(19) United States
(12) Patent Application Publication
(10) Pub. No.: US 2008/0251026 A1
(43) Pub. Date: Oct. 16, 2008

(54) Portable canine urination/decfecation station

(76) Inventors: Mary Bell, Lakeside, CA (US); Ghassan Khalil Elkhoury, Lakeside, CA (US)

Correspondence Address: MARY BELL, 12177 CIMBRIA WAY, LAKESIDE, CA, 92040, US

(21) Appl. No.: 12/082,323

(22) Filed: Apr. 10, 2008

Related U.S. Application Data
(60) Provisional application No. 60/922,762, filed on Apr. 10, 2007.

(51) Int. Cl. A01K 29/00

(52) U.S. Cl. 119/168; 119/169

(57) ABSTRACT

A portable urination/defecation station for use by dogs, cats, and other pets, for urination/defecation comprising: a base tray, with two halves joined at the center with hinges, and a perimeter for holding artificial grass, or other material; locking snaps and a handle for portability. The station includes two additional hinges equal distance from the center line hinge; both sides of the base are pitched to draw urine, with an impressed pan at center of each pitched side, pans hold an absorbent material to contain liquid; the top edge of the perimeter walls are slotted for side panels with a close interference fit, base has an extruded hole at each corner of the perimeter to allow for tent structure; a circular protuberance placed near one corner of the base is for accessories to be affixed, a handle at one end for transportation, and non-sliding protuberances located at each outside corner.

### CROSS-REFERENCE TO RELATED APPLICATIONS

This application claims the benefit of provisional patent application Ser. No. 60/922,762, filed 2007, Apr. 10 by the present inventors.

### FEDERALLY SPONSORED RESEARCH

Not Applicable

### SEQUENCE LISTING OR PROGRAM

Not Applicable

### BACKGROUND

1. Field of Invention

This invention relates to a portable, closable pet relief station used predominately by dogs.

2. Prior Art

Pet owners who were forced to leave their pet home alone for long periods of time were given few options for their pets relieving needs.

Originally pet owners had to either cage their pet inside the house giving the pet no opportunity to relieve themselves, or the owner was forced to allow the pet to urinate or defecate in home.

U.S. Pat. No. 2,671,427 to Fell (1950) offers a portable animal commode that uses branches to capture the animal's attention and peat moss as an absorbent surface. It also folds to a case, however is restrictive on size accommodation and provides no deflection for male dogs to entrap urine.

U.S. Pat. No. 6,059,247 to Olivadoti (2000) displays a diaper pad and pad holder which absorbs urine; however, these pads are unhygienic, and do not allow for more than one or two uses per day. There are also complaints of pets who chew on the pads before and after use. This creates more mess and an even more unhygienic environment with possible choking hazards for the pet.

Other alternatives include U.S. Pat. No. 6,079,363 to MacLaine (2000) which uses a base tray and real grass maintained by a wicking system with multiple trays. This requires daily maintenance and does not allow for ease of portability. The pet is also more inclined to dig at the grass, thus throwing dirt and grass around the area.

Whereas U.S. Pat. No. 4,979,469 to Clark (1990) offers a similar tray system with walls on three sides to provide for male dogs that may lift their leg to urinate. This unit does not supply a natural environment or area for the pet to relieve itself, nor does the unit provide for easy portability or cleaning. The pet is also required to “aim” for certain areas for effective drainage.

While all provide a means to contain pet waste to one area, they suffer from a number of disadvantages:
(a) None of the units referred to offer ease of portability
(b) Each require daily maintenance
(c) Set up time for each is longer than a few minutes and require steps of assembly
(d) Use of one wall for the pet to urinate towards leaves room for error and additional mess on the floor area
(e) Most of the units are not hygienic
(f) Possible choking hazards for the pet

### SUMMARY

It is the objective of this invention to provide a clean, easily transportable, station for urination/defecation indoors or outdoors, by dogs and other household pets.

It is also an objective of this invention to require very low levels of maintenance for the pet owner and an environment conducive to relief impulses for the pet. Thus, the base tray of the unit is designed as such to drain any liquid relieved on the grass to a pan containing an absorbent material which is easily removed and replaced, as well as an artificial grass surface to provide a comfortable environment for pet relief purposes.

This invention is also designed to entrap urine when released by a male dog via adjustable walls that may be configured to create a corner, an entire back enclosure or a three sided enclosure. In addition, the walls offer protection from inclement weather when the invention is being utilized outdoors, on boats, balconies or patios, especially when optional tent cover is utilized.

Furthermore, this invention is designed to be fully self-containing and allow for easy, lightweight transportation and storing through the use of the clamp closure and handle located at the top of the closed unit.

To meet these objectives and the related objectives, the invention may be embodied in the illustrated forms of the accompanying drawings, however it should be understood that the drawings are illustrative only. Variations should be considered part of the invention, limited only by the scope of the claims.

### DRAWINGS

### Figures

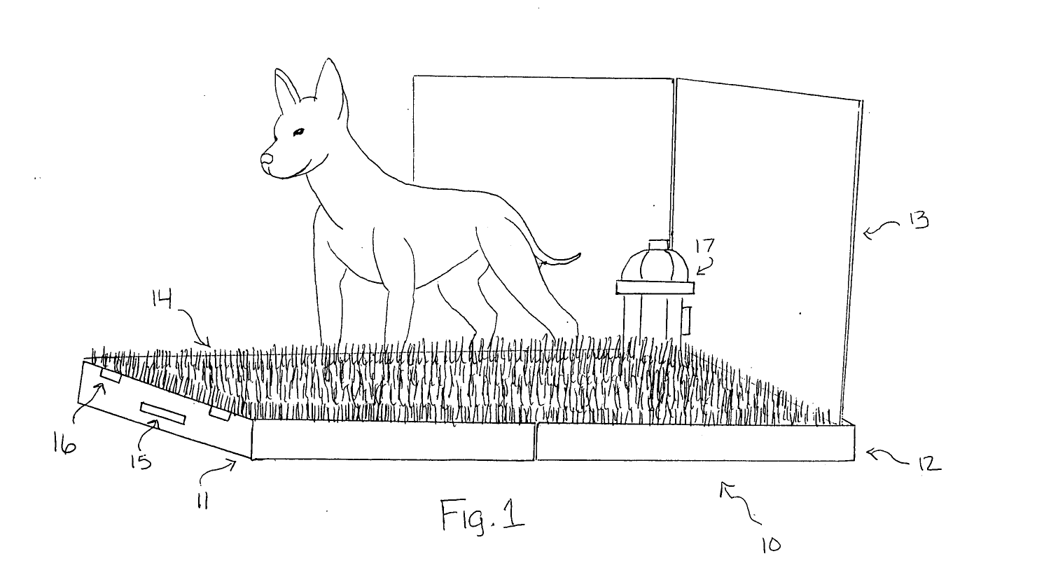

FIG. 1 shows a diagrammatic perspective view of the station in use.

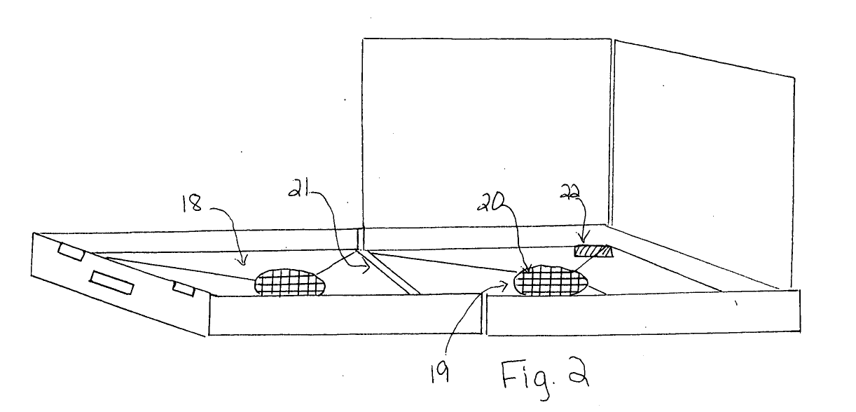

FIG. 2 is a diagrammatic perspective view of the interior base of the station.

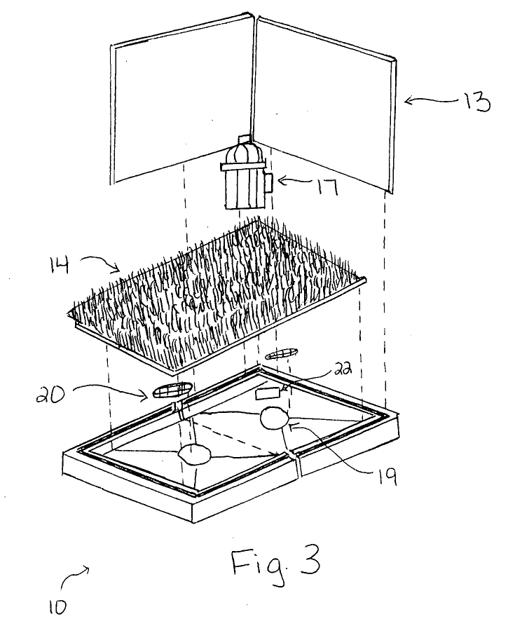

FIG. 3 is an exploded view of the portable urination/defecation station illustrating the relative placement of the artificial grass, splash guard walls, and the optional fire hydrant.

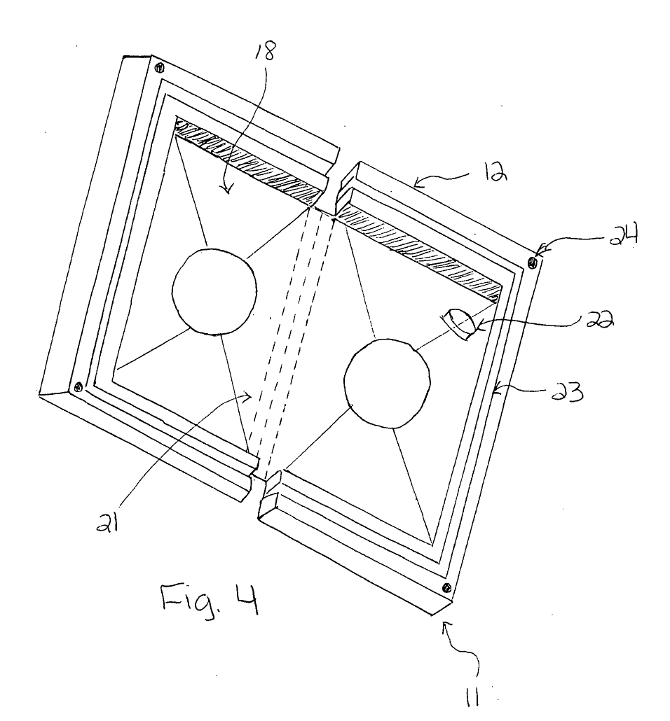

FIG. 4 shows an aerial view of the base illustrating the pitched base, hinge design, and impressed fluid pan with grated covers, as well as the perimeter walls which are slotted or grooved for side panels with a close interference fit, and extruded holes at each outside corner.

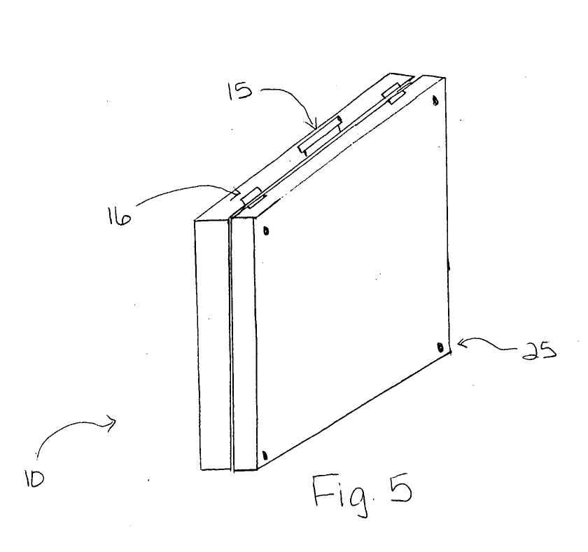

FIG. 5 illustrates the station in the closed state, as well as the non-sliding protrusions located at each corner, the locking clamps, and handle for portability.

DRAWINGS-Reference Numerals

| | | | |
|---|---|---|---|
| 10 | invention | 11 | base |
| 12 | perimeter walls | 13 | splash guard walls |
| 14 | artificial grass | 15 | handle |
| 16 | closure clasps | 17 | fire hydrant accessory |
| 18 | pitch design | 19 | impressed pans |
| 20 | grated covers | 21 | hinge design |
| 22 | protrusion support | 23 | wall grooves or slots |
| 24 | extruded holes | 25 | non-sliding protuberances |

### DETAILED DESCRIPTION

FIG. 1 illustrates a portable canine urination/defecation station 10 for use by dogs, cats, and other pets that are owned as house pets, for urination and defecation, comprising a base 11, perimeter walls 12, removable splash guard walls 13, an artificial grass mat 14, a handle for portability 15, and clasps for closure 16.

The artificial grass 14 is held within the tray by the perimeter walls. The artificial grass provides a natural environment for the pet to urinate or defecate, as well as an effective drainage device for urine to seep through to the impressed pan and absorbent material in the base. The fire hydrant 17, is affixed to the base via a protrusion, and serves as an additional attractant for the pet, and can be an accessory of various design including, but not limited to a fire hydrant, or small tree. This accessory would preferably be constructed of a polypropylene material.

FIG. 2 presents a view of the invention revealing the design of the interior of the base, including the pitch 18 of the interior base, which drains urine to the center impressed pans 19, with the grated covers 20, which contains the absorbent material. Also included is the hinge design 21, which allows the perimeter walls to close flushly at the center line.

FIG. 3 offers an exploded view of the portable canine urination/defecation station 10. This illustrates the ease of assembly, with the grated covers 20, being placed over the impressed pans 19, followed by the artificial grass 14, the fire hydrant, or other accessory 17, which will affix to the base via a protrusion 22 located near one corner of the base 11. Finally the splash guard walls 13 are inserted into the grooves or slots 23, extruded into the perimeter walls 12, of the base 11.

FIG. 4 provides and aerial view of the invention to illustrate the grooves or slots 23, which are extruded from the perimeter walls 12, allowing multiple configurations of the splash walls. This view also illustrates the hinge design 21, in which a hinge falls directly at the center line, with one additional hinge on either side, equally spaced from such center line to allow the center hinge to lie over either side and fully enclose the base 11. Also illustrated are the extruded holes 24 located at each outside corner for placement of optional tent to provide cover for the entire base 11 and splash guard walls. Further illustrated is the pitch design 18 of the base 11 which draws liquid to the impressed pans 19, which will contain the absorbent material. The protrusion 22, is shown as an integral part of the base 11, and spaced equally from the perimeter wall 12, near the corner of the unit.

FIG. 5 presents the invention 10 in a closed state, with one or two snapping closures 16, to lock the unit for transport or storage. The handle 15, is located to the center to provide ease of portability. At each corner of the outside of the base 11, are located non-sliding protuberances 25 to prevent unit from sliding on the floor or area when in use by the pet.

### Operation—

The manner of using the Portable Canine Urination/Defecation Station is to first place the closed unit on the floor where it is to be used, with the hinged side on the floor and the handle facing toward the ceiling. Next, the snap closure should be released to allow the unit to open. Once released, the base tray will be laid open on the floor whereas the middle hinge collapses over either of the side hinges to form a fully enclosed tray. Once the tray is completely flat, the absorbent material is placed in the impressed pans of the base, followed by the grated covers to contain the material to such pans. The artificial grass is then placed in the base, covering the entire, enclosed base area. The optional pop tent is then placed such that the support poles of the tent are locked into the corners of the base tray.

To prepare the Portable Canine Urination/Defecation Station for portability or storage, the unit, once cleaned and free of waste, can be closed while in the “ready to use” state described above. Locking the clasps ensures all materials remain inside the unit and the unit is now ready for portability or storage.

### Advantages—

From the description above, a number of advantages become evident:
(a) The design of the base requires minimal tooling and is cost effective
(b) The hinge design found at FIG. 4 allows the unit to fold closed with artificial grass inside for ease of portability
(c) The pitching of the base draws the liquid to the “pan” and the absorbent material for effortless use by the pet, and a more hygienic environment for the owner
(d) The grooves which support the walls allow for owner specific configuration and protection against leaking
(e) The absorbent material holds many times it's weight in liquid allowing for multiple uses before they must be changed
(f) The grate found at FIG. 3 assures containment of absorbent material for easier cleaning
(g) The snap closure and handle make storage and portability very easy for the owner
(h) Light weight also increases ease of portability

Although the description above contains much specificity, the description should not be construed as limiting the scope of the embodiment but as merely providing illustrations of some of the presently preferred embodiments. For example, the base can be easily sized to accommodate smaller and larger breeds and sizes of dogs.

Thus the scope of the embodiment should be determined by the appended claims and their legal equivalents, rather than by the examples given.

I claim:

1. A portable canine urination/defecation station for use by dogs, cats, and other pets that are owned as house pets, for urination and defecation comprising:
A base tray, with two halves joined at the center line with hinges, and a perimeter for holding artificial grass, or other material; locking snaps and a handle for portability;

2. A portable canine urination/defecation station as recited in claim 1, further including two additional hinges equal distance from the said center line hinge to allow the center hinge to close over either side hinge so as the perimeter walls meet flush at the center line.

3. A portable canine urination/defecation station as recited in claim 1, in which both sides of the base are pitched to draw urine to the center.

4. A portable canine urination/defecation station as recited in claim 1, with an impressed pan at the center of each pitched side, wherein the pans are integral with the base tray.

5. A portable canine urination/defecation station as recited in claim 1, which hold an absorbent bag to contain liquid.

6. A portable canine urination/defecation station as recited in claim 1, further including grated covers for said pans.

7. A portable canine urination/defecation station as recited in claim 1, whereas the top edge of the perimeter walls are slotted or grooved for side panels with a close interference fit, to serve as splash walls to deflect urine into the base.

8. A portable canine urination/defecation station as recited in claim 1, with side panels manufactured in such size as to allow configuration of one to three sides to be blocked within the base.

9. A portable canine urination/defecation station as recited in claim 1, whereas such base contains one hole at each corner, on the top edge of the perimeter to allow for placement of tent structure poles.

10. A portable canine urination/defecation station as recited in claim 1, further including a small, circular protrusion placed near one corner of the base to which accessories, including but not limited to, a fire hydrant, or other accessory can be attached.

11. A portable canine urination/defecation station as recited in claim 1, with a locking system and handle located at one end so when unit is closed it can be transported.

12. A portable canine urination/defecation station as recited in claim 1, which also has non-sliding protuberances at each outside corner to restrict movement of base tray when in use.

13. A portable canine urination/defecation station as recited in claim 1, which is adaptable to pet and owner for use with cat litter for cats and rabbits, artificial turf or sod for dogs, or wetting pads, shredded paper, or wood shaving products.

14. A portable canine urination/defecation station as recited in claim 1, including two additional hinges equal distance from the said center line hinge; and in which both sides of the base are pitched to draw urine to the center, with an impressed pan at the center of each pitched side, wherein the pans are integral with the base tray; said pans hold an absorbent material to contain liquid and are secured with grated covers; and the top edge of the perimeter walls are slotted or grooved for side panels with a close interference fit, additionally, base contains an extruded hole at each corner, on the top edge of the perimeter to allow for placement of tent structure poles; further including a small, circular protuberance placed near one corner of the base to which accessories with located at each outside corner, adaptable to pet and owner for use with cat litter for cats and rabbits, artificial turf or sod for dogs, or wetting pads, shredded paper, or wood shaving products, and lastly portability for use indoors or outdoors, on balconies, and on boats, RVs, etc.
